(19) United States
(12) Patent Application Publication
(10) Pub. No.: US 2026/0079636 A1
(43) Pub. Date: Mar. 19, 2026

(54) EFFICIENT DATA MOVEMENT FOR AI ACCELERATORS

(71) Applicant: Intel Corporation, Santa Clara, CA (US)

(72) Inventors: Andrea Deidda, Leixlip (IE); Alfonso Tarazona Martinez, Celbridge, Co. (IE)

(73) Assignee: Intel Corporation, Santa Clara, CA (US)

(21) Appl. No.: 19/398,767

(22) Filed: Nov. 24, 2025

Related U.S. Application Data
(60) Provisional application No. 63/864,776, filed on Aug. 15, 2025.

(51) Int. Cl. G06F 3/06

(52) U.S. Cl. CPC G06F 3/0647; G06F 3/0604; G06F 3/0644; G06F 3/0673

(57) ABSTRACT

Efficient data movement in neural network accelerators operating within virtualized memory systems is challenged by high address translation latency and unique data access patterns. To address this challenge, address translation prefetch (ATP) mechanisms can be implemented to proactively translate virtual memory addresses before data movement. ATP can be performed in advance of any data movement or concurrently with data movement while being throttled by page transition in the data movement request stream. The ATP mechanism can enforce quotas on outstanding ATP requests, independently for read and write streams, to preserve resources for other processes running on the neural network accelerator. In dealing with competing ATP requests, the mechanism can employ weighted arbitration to balance between different types of ATP requests, utilizing a programmable ratio. The ATP mechanisms enable scalable, high-throughput neural network inference in virtualized environments, addressing data movement bottlenecks in neural network accelerator deployments.

### PRIORITY APPLICATION

This patent application claims priority to and/or receives benefit from U.S. Provisional Application No. 63/864,776, filed on 15 Aug. 2025, titled “EFFICIENT DATA MOVEMENT FOR AI ACCELERATORS USING (sic) A VIRTUALIZED MEMORY SYSTEM.” The US Provisional Application is hereby incorporated by reference in its entirety.

### BACKGROUND

Deep neural networks (DNNs) are used extensively for a variety of machine learning (ML) and artificial intelligence (AI) applications ranging from computer vision to speech recognition and natural language processing due to their ability to achieve high accuracy. However, the high accuracy comes at the expense of significant computation cost. DNNs have extremely high computing demands as there can be a large number of operations as well as a large amount of data to read and write. Reading and writing data can be a bottleneck when executing AI applications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates data movement within a system on-chip, according to some embodiments of the disclosure.

FIG. 2 illustrates one or more address translations from a virtual memory address space to a physical memory address space, according to some embodiments of the disclosure.

FIG. 3 illustrates data being processed and generated by a DNN acceleration circuit, according to some embodiments of the disclosure.

FIG. 4 illustrates a data movement engine, according to some embodiments of the disclosure.

FIG. 5 illustrates timing of software address translation prefetch and timing of hardware address translation prefetch, according to some embodiments of the disclosure.

FIG. 6 illustrates a software prefetch channel, according to some embodiments of the disclosure.

FIG. 7 illustrates an address translation prefetch circuit, according to some embodiments of the disclosure.

FIG. 8 illustrates timing of software address translation prefetching in advance of corresponding data movement, according to some embodiments of the disclosure.

FIG. 9 illustrates a data channel with hardware prefetch, according to some embodiments of the disclosure.

FIG. 10 illustrates an address translation prefetch circuit, according to some embodiments of the disclosure.

FIG. 11 illustrates timing of hardware address translation prefetching in advance of corresponding data movement, according to some embodiments of the disclosure.

FIG. 12 is a flow diagram illustrating a method for prefetching one or more address translations, according to some embodiments of the disclosure.

FIG. 13 depicts a block diagram of an exemplary computing device, according to some embodiments of the disclosure.

### DETAILED DESCRIPTION

DNNs can be represented as a complex graph of interconnected actions or neural network operations. This graph of interconnected actions can be compiled and distilled into a sequence of actions to be performed by one or more hardware components, modules, or parts. Examples of hardware components can include a DNN accelerator, a neural processing unit (NPU), a data processing unit (DPU), a central processing unit (CPU), a graphics processing unit (GPU), a quantum processor, a machine learning processor, an AI processor, a neural network processor, an AI accelerator, an application-specific integrated circuit (ASIC), an analog signal processor, an analog computer, a microprocessor, a digital signal processor, a field programmable gate array (FPGA), a tensor processing unit (TPU), a neural network hardware accelerator, etc.

Data movement efficiency for the variety of hardware components accelerating execution of the actions or neural network operations is important to attain application performance and energy efficiency. The hardware components such as the NPU are increasingly deployed within or integrated into complex System on-Chip (SoC) architectures, where the hardware component share acts as one of the devices in the SoC that shares access to external physical memory resources with the rest of the SoC. The external physical memory can be managed by operating system-level memory virtualization.

Each application, including the one being executed on the hardware accelerator, can be isolated and may be given use of the entire memory address space. This mechanism is called memory virtualization and allows multiple applications to effectively share the same physical memory through the operating system (OS) managed memory virtualization system. The memory address space is seen as a set of OS-managed memory pages, whose size is a system parameter. The cost of memory virtualization in terms of performance can be very high, as every access to memory may go through a complex system of multiple address translations (AT) before reaching the external memory.

In contexts outside of ML and AI, AT performance and costs are tackled by exploiting both spatial and temporal locality and multi-layer hardware cache hierarchy that is under software management. The principle of operation is that each translation is stored in a cache memory and reused when locality demands translating the same address. Unfortunately, these solutions are insufficient when applied in context within ML and AI.

Applications in ML and AI, involving execution of neural network operations, are characterized by a massive volume of data to be processed, where it is paramount to efficiently move the data external memory through the virtualized memory system. Complexity of data movement patterns is a key differentiator where ML applications lack both spatial and temporal data reuse needed to take advantage of hardware caching hierarchies for virtual memory AT. While this virtualization enables flexible resource sharing and isolation, it introduces significant performance overhead due to frequent address translations from virtual to physical memory addresses. Frequent address translations impose a challenge that is particularly acute for machine learning workloads, which often lack the spatial and temporal locality to benefit from conventional hardware caching strategies. Since AT cost dominates the overall hardware accelerator external memory access performance, the technical problem to address is how a ML hardware accelerator can access external memory as efficiently as possible.

In one approach, application locality could be increased by changing how ML and AI data is stored on memory according to the use of data. However, this is not always possible if there is no control over the application itself. In one approach, temporal locality could be increased by triggering translations ahead of time of data use. However, this is not always possible if there is no control over the application itself. Even, if possible, the temporal locality suffers from cache replacement policies and cannot guarantee optimal solutions in ML applications. In one approach, use of hardware that automatically triggers next page address translation based on heuristics on the data pattern seen in the path to memory. While this can provide some efficiency, this is fundamentally limited by the lack of a-priori knowledge of the data movement pattern the application will perform. These approaches cannot optimally solve the problem in ML applications.

Implementations of data movement acceleration (DMA) hardware module to facilitate data movement are described in US Patent Publication No. 2023/0259467, which is hereby incorporated by reference in its entirety. DMA hardware module may also be referred to as direct memory access engine, or data movement engine, in some contexts.

To address AT costs, hardware and/or software assisted mechanisms for efficient hardware accelerator access to external memory in a virtualized memory system can be implemented in a data movement engine, while maintaining support for the complex data movement patterns utilized in modern ML applications which lack spatial and temporal data locality. The hardware and software assisted address translation prefetch mechanisms address the technical problem of efficiently moving large volumes of data between external memory and ML accelerators in such virtualized environments, focusing on making overall memory access time independent from or no longer dependent on the latency and overhead associated with address translation.

The data movement engine can support a neural network acceleration circuit that performs one or more neural network operations based on at least one or more of a weight and an activation of a neural network or neural network model. The system, device, or apparatus having the neural network acceleration circuit further includes a memory accessible by the neural network acceleration circuit. The memory stores at least one or more of the weight and the activation. The system, device, or apparatus can include a further memory. The data movement engine can move at least one or more of the weight and the activation to and/or from the memory and the further memory. In some embodiments, a data movement engine is equipped with an address translation prefetch (ATP) circuit. The ATP circuit can proactively trigger translation of virtual addresses to physical addresses before data movement requests are issued and can cause the address translations to be cached for subsequent use.

In one example, the ATP circuit can receive a task configuration comprising a data movement pattern of one or more pages or memory pages. Herein, a task configuration can be a descriptor specifying a data-movement pattern, including start address, size, and optional stride(s). The one or more pages may correspond to at least one or more of a weight and an activation of a neural network. The ATP circuit can trigger (or cause the processing and/or completion of) address translation of a virtual memory address associated with a page in the one or more pages to a physical memory address prior to the data movement engine making a request to move the page. The ATP circuit can trigger a number of one or more address translations from a virtual memory address space to a physical memory address space for the one or more pages. Herein, a number of one or more address translations means a number of address translations where the number is ≥1. The ATP circuit can track whether an address translations has been completed. The one or more address translations can be stored in a cache for subsequent use. After the number of one or more address translations are performed, the ATP circuit can make or issue a data movement request to move the one or more pages between a memory and a further memory (e.g., perform a read request or a write request) without incurring address translation latency, since the one or more address translations are stored in the cache. Phrased differently, the ATP circuit waits for the address translation from a virtual memory address to a physical memory address to be completed before issuing a data movement request using the virtual memory address. Doing so can ensure that the address translation is cached and ready, without incurring address translation costs during data movement.

The data movement engine can support a software prefetch mode. In software prefetch mode, a dedicated hardware ATP circuit executes prefetch tasks independently of data movement, allowing compiler-driven control over ATP scheduling and enabling prefetching in advance of actual data transfers.

The data movement engine can support a hardware prefetch mode. In hardware prefetch mode, the data channel to move data incorporates an ATP circuit can identify the working set of memory pages for a given task and triggers ATP requests in synchronization with actual data movement. At least some of the ATP requests are made concurrently with data movement. The ATP circuit can initially translate a programmable stride of address translations to cover startup latency and then perform further address translations as the data movement request stream crosses page boundaries. The further address translations are throttled by actual data movement.

For software prefetch mode, the number of address translations to perform in advance of data movement can be set by the compiler and/or by firmware. For hardware prefetch mode, the startup stride of address translations can be set by the compiler and/or by firmware. Herein, startup stride can refer to an integer S≥1 defining the count or number of address translations to be performed before permitting issuance of the first data movement request task. Configuring these parameters helps manage cache usage effectively and prevents the cache from becoming overfilled, thereby reducing the risk of premature overwriting or loss of address translations.

The data movement engine can enforce one or more quotas on the number of outstanding ATP requests during a time period. Setting a quota can be beneficial to ensure that the finite cache resource is used effectively by address translation prefetch circuits and other processes that may also be utilizing the data movement engine. In some embodiments, quotas can be set separately for address translation requests for read and write data movement operations. In some embodiments, quotas can be set separately for address translation requests associated with software and hardware prefetch modes.

The data movement engine can implement arbitration ensure efficient prioritization of requests, since there may be one or more competing ATP requests during a given clock cycle or time period. The arbitration can use weighted round-robin policies and programmable ratios to balance different ATP requests, e.g., ATP requests associated with software versus hardware prefetch modes, and ATP requests associated with read and write data movement operations, as well as read and write data movement operations. In some embodiments, the arbitration can prioritize ATP requests associated with hardware prefetch mode over ATP requests associated with software prefetch mode. In some embodiments, the arbitration can prioritize ATP requests associated with read data operations over ATP requests associated with write data operations.

Empirical results demonstrate that enabling ATP mechanisms in the data movement engine for ML and AI applications can significantly improve external memory access performance. High bandwidth data movement as if there was no memory virtualization can still be achieved, even when address translation latency is high (e.g., tolerating thousands of clock cycles of address translation latency). ATP mechanisms can be particularly beneficial for memory-bound workloads such as operations associated with large language models, which exhibit minimal spatial and temporal data locality. By reducing the cost of virtualized memory access, both performance per watt and energy efficiency, especially in battery-operated devices, are both improved.

Data Movement Engine with Address Translation Prefetch

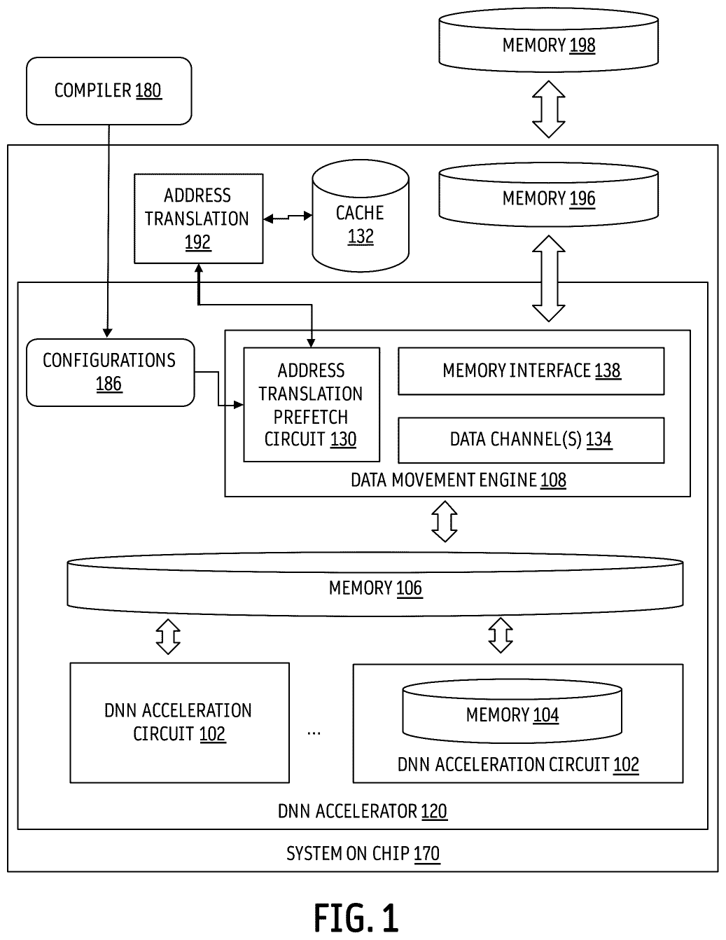

FIG. 1 illustrates data movement within SoC 170, according to some embodiments of the disclosure. SoC 170 can be an integrated circuit that integrates various components or circuits of a computer or electronic system, such as different types of processors different types of hardware accelerators, memory, input/output ports, and often onto a single chip or package.

SoC 170 may include DNN accelerator 120. In some cases, SoC 170 may include one or more instances of DNN accelerator 120. SoC 170 may include other processing components such as a CPU, a GPU, a digital signal processor (DSP), an image signal process (ISP), etc.

DNN accelerator 120 may be a hardware accelerator designed to accelerate execution of neural network operations or other computing operations. DNN accelerator 120 may include one or more compute engines that are optimized to perform neural network operations commonly found in neural networks, such as convolutions, matrix multiplications, applying activation functions, reshaping of tensors, etc. An exemplary compute engine to accelerate neural network operations is shown in FIG. 1 as DNN acceleration circuit 102. Examples of the one or more compute engines in DNN accelerator 120 can include a digital signal processor, a systolic array, multiply and accumulate array, analog compute-in-memory array, digital compute-in-memory array, an ASIC, a vector data processing circuit, a scalar data processing circuit, tensor processing circuit, reconfigurable fabric such as a FPGA, etc.

Compiler 180, e.g., executing on a computing system, may receive a high-level neural network model definition and generate low-level machine-readable instructions, such as configurations 186, based on the definition. In some embodiments, compiler 180 ingests a graph of layers, operations, and tensors, produces an internal intermediate representation. Compiler 180 can apply optimizations such as fusion, scheduling, precision/layout propagation, and memory planning to match data-processing pipeline of DNN accelerator 120. From the optimized processing graph, compiler 180 can partition the operations in the graph into workloads for DNN accelerator 120 and perform various optimizations such as tiling and data movement optimizations. Compiler 180 can convert the workloads into configurations 186 (e.g., referred to as configuration descriptors in some contexts), which are structured command blocks that configure blocks in DNN accelerator 120 and/or blocks in DNN acceleration circuit 102 to execute neural network operations. One example of configurations 186 may include or specify one or more of: operation type, control flags, kernel and/or tensor metadata (e.g., dimensions, strides, dilation, padding, size, data formats, sparsity bitmaps, etc.), memory access/mapping information (e.g., source memory addresses, destination memory addresses, data size), post-processing parameters (e.g., bias addition, activation function information, quantization, etc.), etc. In some embodiments, configurations 186 may include data movement tasks (e.g., encoded as task configurations or data movement task configurations) that support data movement for executing one or more neural network operations. Configurations 186 may be loaded onto DNN accelerator 120 to configure DNN accelerator 120 to perform one or more neural network operations.

SoC 170 can leverage a multi-level or hierarchical memory system having one or more of: large off-chip memory (e.g., shown as memory 198 that is external to SoC 170), limited on-chip memory (e.g., shown as memory 196 as part of SoC 170), intermediate on-chip memory (e.g., shown as memory 106 as part of DNN accelerator 120), and local memory such as register files or memory cells within a compute engine for immediate data access (e.g., shown as memory 104). In some embodiments, memory may be organized as pages of a certain size (e.g., 4 kilobytes (KB)). Page size may be configurable or differ depending on the memory system implementation.

Data can be moved between different memories in the memory system when DNN accelerator 120 is executing one or more neural network operations. Data can flow from off-chip memory (e.g., memory 198) into the on-chip memory (e.g., memory 196) of SoC 170 for staging, then into intermediate buffers (e.g., memory 106) within DNN accelerator 120 to feed the local memory of a high-throughput compute engine (e.g., memory 104 of DNN acceleration circuit 102). Operands from intermediate buffers within DNN accelerator 120 can be loaded into the local memory of the compute engine (e.g., memory 104 of DNN accelerator circuit 102) for cycle-level execution. After computation by the compute engine, intermediate results can be written to the local memory of the compute engine and reused for one or more next cycles if appropriate. Final results can be written to the local memory of the compute engine, and the final results can propagate back through the hierarchy, e.g., first to intermediate buffers (e.g., memory 106) for optional reuse within DNN accelerator 120, then to the on-chip memory (e.g., memory 196) of SoC 170, and finally to off-chip memory (e.g., memory 198) if appropriate. Efficient scheduling and tiling strategies are often employed to minimize redundant data movement and exploit spatial and temporal data reuse across these memory levels within the memory system.

The hierarchical movement of data across memory levels is complicated by the presence of one or more layers of memory virtualization. These layers can be introduced by the operating system, device-level isolation mechanisms, input/output (I/O) memory management units (MMUs), hypervisor or operating system managing multiple virtual machines (VMs), each layer of which may enforce its own virtual to physical address translation.

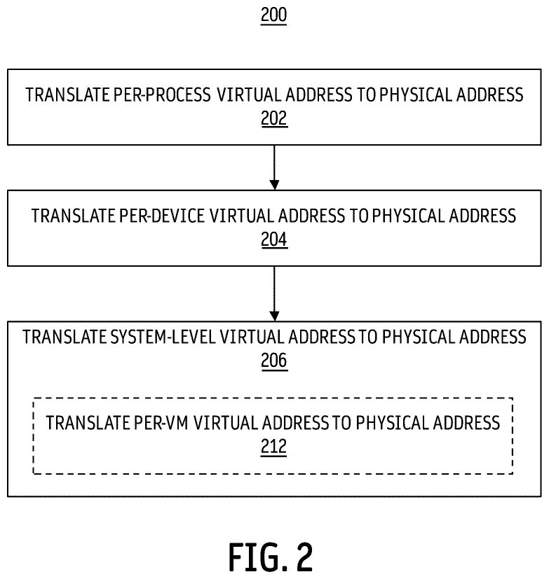

At the lowest level, DNN accelerator 120 can operate within its own virtual address space, managed by an internal MMU. Each process or thread running on the accelerator can be assigned a virtual memory view. The internal MMU within DNN accelerator 120 can translate these virtual addresses to physical addresses within the local memory (e.g., memory 106) of DNN accelerator 120. This translation is represented as operation 202 in method 200 of FIG. 2, where per-process virtual addresses are translated to physical addresses.

Above this, DNN accelerator 120 itself can be isolated from other components or devices on SoC 170, often using a device-specific translation lookaside buffer to map device-local addresses to system-level addresses. This layer translates addresses from the local device address space of DNN accelerator 120 to the physical address space of SoC 170, ensuring that memory accesses are properly routed and isolated from other devices. This translation is represented as operation 204 in method 200 of FIG. 2, where per-device virtual addresses are translated to physical addresses.

Above this, SoC 170 may include an I/O MMU that manages address translation for all devices within SoC 170 communicating with external memory (e.g., memory 198). The I/O MMU translates system-level addresses to the actual physical addresses in off-chip memory (e.g., memory 198). This translation is represented as operation 206 in method 200 of FIG. 2, where system-level virtual addresses are translated to physical addresses.

Within the highest level, the operating system or hypervisor may impose additional address translations, especially in environments with nested virtualization and/or multiple virtual machines. The operating system or hypervisor may give each virtual machine or container its own virtual address space, which can be mapped to the host system's physical address space. This translation is represented as operation 212 in operation 206 of FIG. 2, where per-VM virtual addresses are translated to physical addresses.

This address translation process can significantly degrade throughput for workloads often found in neural network model execution, where memory access patterns can be pseudo-random and lack the spatial or temporal locality that other workloads exploit for caching. Referring back to FIG. 1, the address translation operations illustrated in FIG. 2 are illustrated as being performed in address translation 192, and the address translations can be cached in cache 132 accessible to address translation 192. Address translation 192 may include one or more MMUs or that can translate virtual memory addresses to physical virtual memory addresses.

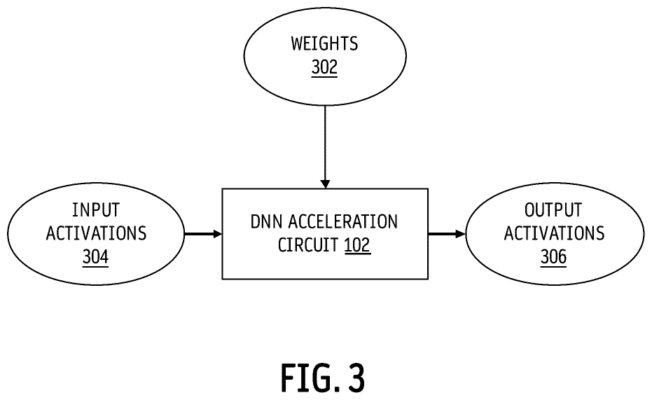

DNN acceleration circuit 102 may accelerate operations in neural network model execution. FIG. 3 illustrates an example operation that can be accelerated by DNN acceleration circuit 102. DNN acceleration circuit 102 may receive operands such as input activations 304 and optionally weights 302. DNN acceleration circuit 102 may apply weights 302 to input activations 304 to transform input activations 304 and generate output activations 306. Notably, weights 302 and input activations 304 are frequently used only once per computation cycle of DNN acceleration circuit 102, thus have little spatial and temporal locality to exploit cache hits to reduce the impact of address translation latency. Weights 302 are read in large, often pseudo-random blocks, lacking spatial or temporal locality, which makes caching ineffective. Input activations 304 and/or output activations 306 are produced internally and ideally remain within the local memory (e.g., memory 104) of DNN acceleration circuit 102 of FIG. 1). However, due to limited internal capacity, they are frequently spilled to external memory, incurring additional latency and bandwidth costs when swapped in and out. Output activations 306, similarly, are generated and consumed layer by layer, with each output becoming the next layer's input, and are also subject to external memory transfers when internal resources are insufficient. Across all three, the nature of the workloads makes it impractical to rely on cache hits to mask address translation latency.

As a result, every memory access may incur the full cost of traversing multiple translation layers (e.g., as illustrated in FIG. 2), amplifying the impact of translation misses and page faults. To mitigate these effects, data movement engine 108 of FIG. 1 responsible for moving data between memory outside DNN acceleration circuit 102 and memory inside DNN acceleration circuit 102 (e.g., memory 104 of DNN acceleration circuit 102) may implement address translation prefetch circuit 130. In particular, address translation prefetch circuit 130 can trigger address translation 192 to perform warm up of address translations and trigger address translation 192 to store one or more address translations in cache 132 prior to or in advance of the data movement, so that data movement can become independent of the address translation latency.

Address translation 192 can be implemented outside of data movement engine 108. Address translation 192 can involve performing address translations across different points in the memory hierarchy, whenever an address translation is to be performed between different memory address spaces, as illustrated in FIG. 3. Address translation 192 can include one or more MMUs.

Address translation prefetch circuit 130 can proactively trigger and instruct address translation 192 (e.g., the MMUs therein) to translate a virtual address across the memory hierarchy into a final physical address and to store the address translations in cache 132 before the data movement requests are issued. As a result, the MMUs in address translation 192 can reuse the cached address translation with no address translation latency penalty when the data movement requests are performed.

In particular, address translation prefetch circuit 130 can track whether a virtual memory address for a memory page has been successfully translated by address translation 192. Address translation prefetch circuit 130 can assume that the address translation would be cached by address translation 192. When data movement engine 108 issues a data movement request to move the memory page, data movement engine 108 can use the virtual memory address for the memory page without incurring address translation latency penalty.

Data movement engine 108 may further include memory interface 138 that connects the memory outside DNN acceleration circuit 102 and memory inside DNN acceleration circuit 102 (e.g., memory 104 of DNN acceleration circuit 102), to facilitate data transmission and transfer.

Data movement engine 108 may further include one or more data channels 134, which can include one or more dedicated circuits for processing and executing data movement tasks to move data across memory interface 138. Each data channel can operate independently, allowing for parallel execution of multiple data movement operations.

The data movement being carried out by the one or more data channels 134 across the memory hierarchy can leverage the one or more address translations warmed up by address translation 192 and stored in cache 132, so that no address translation latency penalty is incurred.

In some implementations where hardware prefetch mechanisms are implemented, a data channel of one or more data channels 134 can implement logic to manage execution of data movement tasks across memory interface 138, while coordinating with address translation prefetch circuit 130 to ensure that data movement is occurring concurrently with and after address translations are complete.

Herein, a channel may refer to hardware resources and/or circuitry dedicated to process and execute a data movement task, which may include data movement or may not include data movement (e.g., an address translation prefetch task). A data movement engine may include multiple channels in parallel (and independent of each other) to allow for parallel execution of data movement tasks

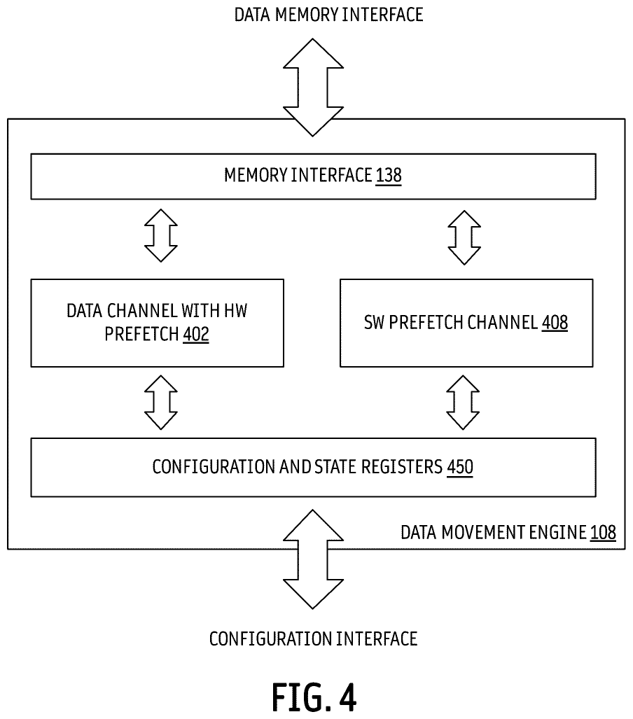

As illustrated in FIGS. 4-11, address translation prefetch circuit 130 can improve external memory access performance by supporting software prefetch mode and/or hardware prefetch mode to warm up memory accesses by ensuring that address translations are cached in cache 132 by address translation 192 prior to data movement by one or more data channels 134 across memory interface 138.

Address translation prefetch circuit 130 can submit an ATP request that triggers address translation 192 to perform an address translation of a virtual memory page address in a virtual memory space to a physical memory page address in a physical memory space, across the memory hierarchy. The mechanism to trigger the address translation to be performed by address translation 192, ahead of actual data movement or the request to perform data movement, can be referred to as prefetch.

The ATP request to perform address translation of a virtual memory address to a physical address can be triggered by address translation prefetch circuit 130 to cause address translation 192 to perform the address translation in advance of the actual data transfer request targeting the same virtual memory address being used by a data channel of one or more data channels 134 to move the data. The address translation performed by address translation 192 can be stored in cache 132. Address translation prefetch circuit 130 thus causes address translation 192 to perform a warm up mechanism to reduce the impact of the address translation latency on the actual data transfer, making the data transfer independent from the address translation latency.

From a system point of view, a data channel in one or more data channels 134 data movement engine 108 can issue a data movement request to move data via memory interface 138 based on a data movement pattern. Address translation prefetch circuit 130 may issue an ATP request based on a data movement pattern but with no data movement being requested. In some implementations, address translation prefetch circuit 130 may identify a data movement request as an ATP request using specific transfer metadata (e.g., control flag(s) or bit(s)) in the data movement request.

FIG. 4 illustrates data movement engine 108, according to some embodiments of the disclosure. To offer flexibility in terms of application use cases and/or adapting to different types of workloads, data movement engine 108 can support software prefetch mode and/or hardware prefetch mode. Data movement engine 108 may have configuration and/or state registers 450 to maintain configuration values and/or states.

In the software prefetch mode, address translation prefetch circuit 130 as depicted in FIG. 1 can be implemented as software (SW) prefetch channel 408. SW prefetch channel 408 includes dedicated hardware that can operate independently from the data channels to warm up address translations before actual data movement requests are executed by the data channels. SW prefetch channel 408 supports generating one or more ATP requests with no data movement capabilities. By supporting software prefetch mode, data movement engine 108 can initiate address translation in advance, to store address translations in cache 132 prior to data movement. SW prefetch channel 408 can remove or hide the startup latency penalty.

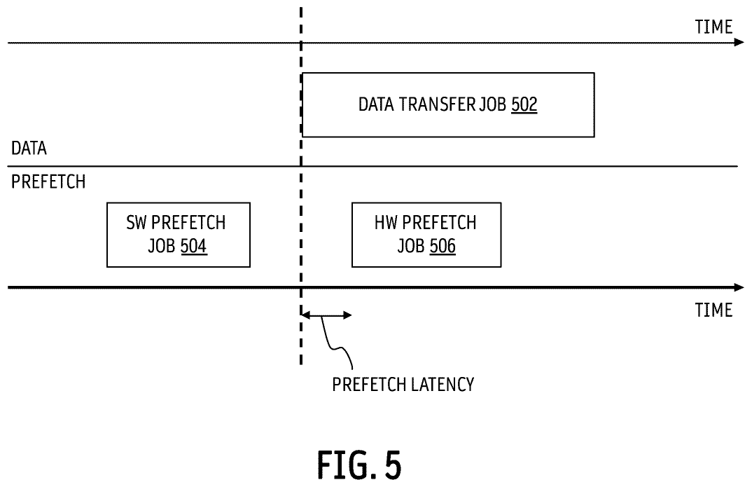

As illustrated in FIG. 5, SW prefetch channel 408 can issue an ATP request to perform SW prefetch job 504 before data transfer job 502 is being carried out. In some embodiments, SW prefetch channel 408 may use the same job descriptor to trigger SW prefetch job 504 as the job descriptor used to trigger the data transfer job 502, but with a control bit in the job descriptor to flag the job as a SW prefetch job 504 that performs ATP and to denote that the job is not associated with data transfer. SW prefetch job 504 may be triggered or initiated at a suitable time before data transfer job 502 is started.

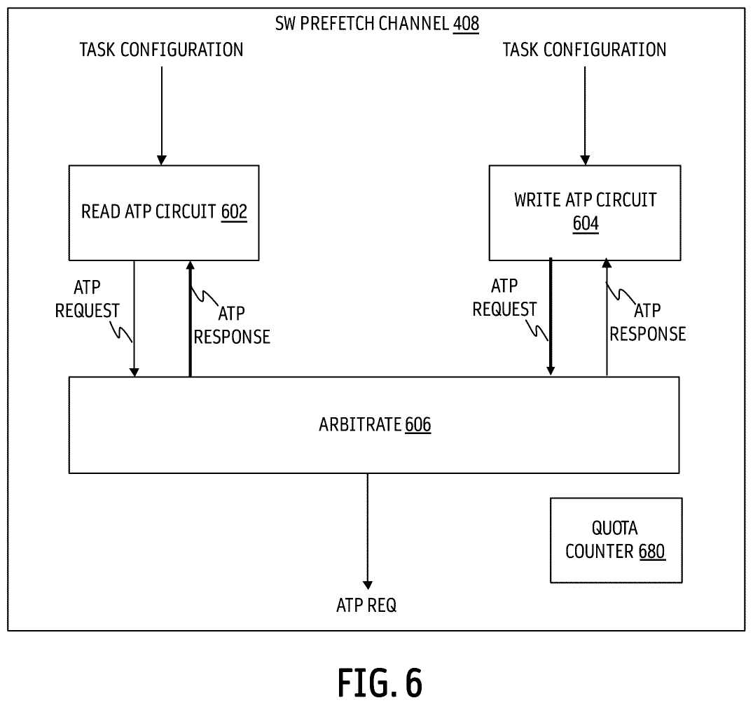

Referring back to FIGS. 4-5, one or more software ATP requests can be triggered based on a data movement task being executed on dedicated circuitry, e.g., SW prefetch channel 408, which is decoupled and independent from hardware components that perform data movement. As discussed previously with FIG. 1, an application compiler, e.g., compiler 180 of FIG. 1, encodes data movement tasks as task configurations, and incorporates the task configurations as part of compiled configurations (e.g., configurations 186 of FIG. 1). Accordingly, the application compiler can control and trigger SW prefetch channel 408 to execute SW prefetch job 504 of FIG. 5 by including a task configuration that configures SW prefetch channel 408 to execute SW prefetch job 504. Specifically, the task configuration specifying SW prefetch job 504 can trigger SW prefetch channel 408 to perform one or more ATP requests in advance of the actual data movement process. In some embodiments, the task configuration specifying the SW prefetch job 504 of FIG. 5 encodes the same data movement pattern of a future data movement task. Compiler (or SW) control of address translation prefetching can eliminate the initial translation latency from data transfer job 502, thus speeding up the overall neural network model execution. Additional details for SW prefetch mode are illustrated in FIGS. 6-8.

Referring back to FIG. 4, in the hardware prefetch mode, address translation prefetch circuit 130 as depicted in FIG. 1 is integrated directly with a data channel and can be implemented as data channel with hardware (HW) prefetch 402. The prefetch functionality of address translation prefetch circuit 130 is tightly coupled with the execution of data movement operations of a data channel, where at least one or the ATP requests are triggered concurrently with data movement. Data channel with hardware (HW) prefetch 402 integrates generating ATP requests in parallel with data movement logic. This integration enables address translations to be prefetched in tandem with the data movement process.

As illustrated in FIG. 5, data channel with HW prefetch 402 can issue one or more ATP requests as part of HW prefetch job 506, and HW prefetch job 506 is running concurrently with data transfer job 502. The address translation of one or more page addresses of HW prefetch job 506 can be issued just-in-time, e.g., racing ahead of, data transfer in data transfer job 502. The data movement request stream in data transfer job 502 can throttle to sync with ATP requests. This synchronization ensures that data movement does not outpace the completion of address translations. Startup or prefetch latency is exposed, where data transfer job 502 waits for a startup stride of address translations to be performed before initiating or commencing the data transfer. Executing a startup stride of initial address translations can coordinate the timing of address translations with the subsequent data movement so that address translation latencies are masked.

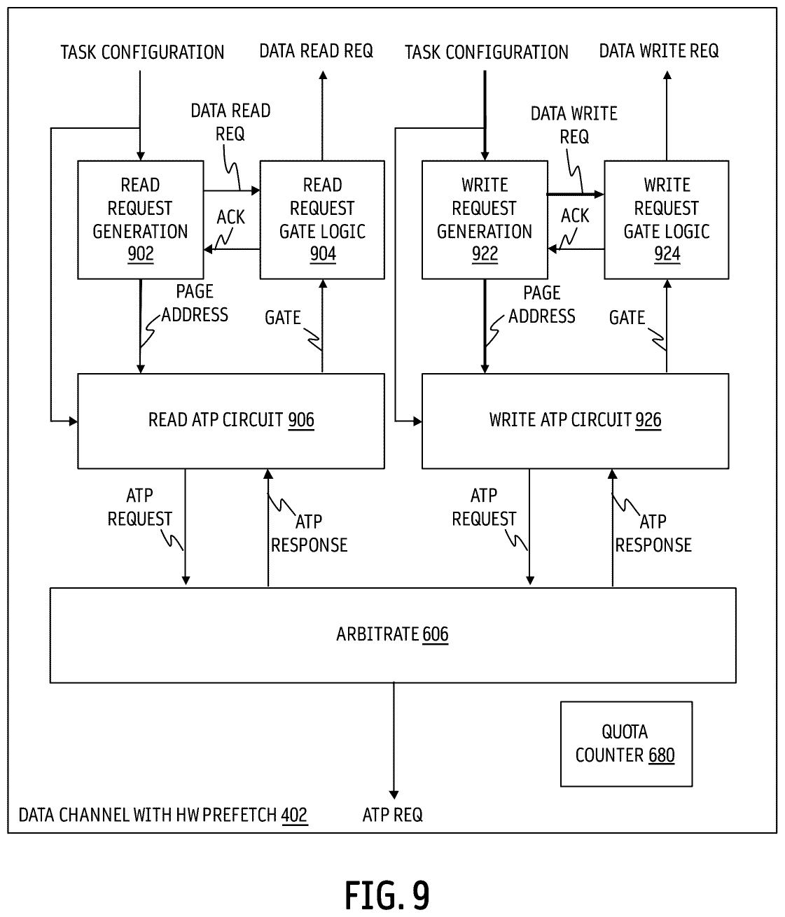

Referring back to FIG. 4, one or more hardware ATP requests can be generated by data channel with HW prefetch 402, which is also processing and performing the actual data movement. A task configuration encoding a data movement task can optionally include a control flag to enable and use the hardware address prefetch circuit. Data channel with HW prefetch 402 can parse the task configuration to generate one or more hardware ATP requests for one or more memory pages of the data movement task in advance of data transfer of the one or more memory pages. Data channel with HW prefetch 402 may perform a startup stride of initial address translations in advance of data transfer as a warm up mechanism. In some embodiments, data channel with HW prefetch 402 can generate further hardware ATP requests at page granularity, e.g., incrementally on subsequent pages encountered for the data movement task, triggered by page transitions (or crossings) detected in the data movement request stream. Herein, a page transition or crossing refers to a page address crossing a page boundary, or when a page that is different from a current page is being referenced. Data channel with HW prefetch 402 can maintain a tight synchronization between an ATP request and an actual page of data read or write being requested in the data movement request stream. Data channel with HW prefetch 402 can ensure that data read or write requests for a target page are issued only after the ATP request for that target page has completed (e.g., an ATP response for that target page has been received by data channel with HW prefetch 402). The lock-step operation of data channel with HW prefetch 402 ensures that an address translation is available for a data movement request before the data movement request is issued, avoiding any stalling due to non-availability of a translation and avoiding cache trashing scenarios. In some embodiments, data channel with HW prefetch 402 can sustain both read and write associated ATP requests concurrently. Additional details for HW prefetch mode are illustrated in FIGS. 9-11.

### ATP Requests and Responses

An ATP request may trigger an address translation of a virtual memory page address to a physical memory page address to be performed by one or more MMUs (e.g., in address translation 192 of FIG. 1). The ATP request may include at least one or more of: a virtual memory page address that is to be translated, a request type indicating that the request is an ATP request that is not associated with data movement, a request identifier (ID) uniquely identifying the ATP request to track and match ATP responses, whether the ATP request is for a read or a write data movement operation, and whether the ATP request is for SW prefetch mode or HW prefetch mode.

An ATP response may indicate that the address translation prefetch request for a virtual memory page address has been completed or processed. The ATP response can indicate that the address translation for the virtual memory page address is available in the cache (e.g., cache 132 of FIG. 1). The ATP response may include at least one or more of: a request ID corresponding to the request ID of the ATP request that has been completed, a status or ready signal indicating that the address translation is ready, and the virtual memory page address that was translated.

### Data Movement Pattern

Task configurations can include a data movement pattern to guide the data movement engine to perform software and/or hardware prefetch. The data movement pattern can be specified by a starting memory address and an amount of data to be moved. The data movement pattern of one or more pages may include information about how data is to be transferred or moved between memories. The movement pattern may specify the starting virtual memory (page) address, indicating where the data movement begins, and the total size of the transfer, which determines how much data will be moved. In some embodiments, the data movement pattern may include the stride, which is the step size between consecutive memory accesses (e.g., used for moving multi-dimensional data structures, such as tensors, where the stride determines how the hardware jumps from one row or block to the next). For more complex data, the data movement pattern may specify additional dimensions, such as width, height, or depth, to describe the shape and layout of the data being moved. The data movement pattern may include the direction of the transfer, e.g., whether it is a read from memory to another memory or a write from a memory to another memory. In some embodiments, the data movement pattern may specify a pattern type to indicate whether the data is to be moved according to a certain pattern (e.g., linear, strided, multi-dimensional, batched, offsets).

### Software Prefetch Mode

FIG. 6 illustrates software prefetch channel 408, according to some embodiments of the disclosure. Software prefetch channel 408 may include one or more ATP circuits, e.g., read ATP circuit 602 and write ATP circuit 604. Parallel ATP circuits corresponding to read and write data streams respectively can track both read and write operations respectively with external memory. An ATP circuit can implement logic for triggering one or more ATP requests and monitoring for one or more ATP responses. Read ATP circuit 602 may implement logic for triggering ATP requests associated with data read operations. Write ATP circuit 604 may implement logic for triggering ATP requests associated with data write operations. Read ATP circuit 602 and write ATP circuit 604 may be implemented similarly, or may be combined together in some embodiments.

An ATP circuit may receive a task configuration comprising a data movement pattern of one or more pages. The one or more pages may correspond to at least one or more of a weight and an activation of a neural network. The ATP circuit can trigger address translation of a virtual memory address associated with a page in the one or more pages to a physical memory address prior to the data movement engine making a request to move the page between a memory and a further memory. The ATP circuit can trigger an address translation by outputting an ATP request. The ATP circuit can monitor for an ATP response to assess whether the ATP request has been completed. The ATP circuit can receive an indication in the ATP response that the address translation is stored in the cache.

In some embodiments, SW prefetch channel 408 is triggered by task configuration(s) from and/or generated by a compiler. The compiler generates configurations to configure the neural network acceleration circuit to perform the one or more neural network operations. The ATP requests are sent by the ATP circuit of SW prefetch channel 408 at the instruction of the compiler that is responsible for planning ahead and obtaining address translations ahead of subsequent data transfers.

In some embodiments, the ATP circuit can trigger a number of one or more address translations from a virtual memory address space to a physical memory address space for the one or more pages in advance of a data movement request stream receiving a request to move the one or more pages between the memory and the further memory. The number of one or more address translations is programmable or configurable, e.g., by a compiler and/or by firmware controlling SW prefetch channel 408. In some embodiments, the compiler can specify the number of one or more address translations in the task configuration.

In some embodiments, SW prefetch channel 408 may include quota counter 680 that monitors a number of outstanding address translations, and optionally other information about the outstanding address translations (e.g., whether the outstanding address translation requests are associated with data reads versus data writes, or whether the outstanding address translation requests are associated with software prefetch or hardware prefetch). Quota counter 680 can limit a number of outstanding address translations (e.g., outstanding ATP requests) during a time period. Quota counter 680 can include a configuration register storing a number of outstanding address translations allowed for the address translation prefetch circuit during a time period. The number of outstanding address translations can be programmable or configurable. The number of outstanding address translations can correspond to data read operations. The number of outstanding address translations can correspond to data write operations.

In some embodiments, quota counter 680 may support a maximum of K (e.g., K=48, 64, or 128) outstanding ATP requests (e.g., per memory interface) at a given point in time or during a time period. The K number of ATP requests enforced by quota counter 680 can be shared by both read and write ATP request streams. In some embodiments, quota counter 680 may enforce separate limits for read ATP request streams and write ATP request streams. If the limit enforced by quota counter 680 is shared by both read and write ATP request streams, the degree of sharing can be controlled by a relative quota defining the maximum number of outstanding ATP requests a specific stream (e.g., a read ATP request stream or a write ATP request stream) can have at a given point in time or during a time period. The relative quota can be programmable on one or more configuration registers of quota counter 680.

In some embodiments, the quotas are defined separately for read or write ATP request streams. A configuration register of quota counter 680 may be used to program a quota for the read ATP request stream, e.g., RD_QUOTA. A further configuration register of quota counter 680 may be used to program a quota for the write ATP request stream, e.g., WR_QUOTA. In some implementations, RD_QUOTA=WR_QUOTA=K means that both read and write ATP streams can consume all the K outstanding ATP request slots if there are available slots for the corresponding stream.

Setting a relative quota and/or separate quotas for each stream enable quota counter 680 to prioritize or balance memory address translation prefetch requests according to the specific data movement patterns of different neural network operation executions, ensuring that one stream does not consume all available ATP slots.

In some embodiments, SW prefetch channel 408 includes arbitrate 606. While quota counter 680 may enforce limits on outstanding ATP requests, arbitrate 606 performs one or more mechanism that selects one ATP request to service from one or more concurrent ATP requests being made to an ATP request stream. Arbitrate 606 can ensure that different types of ATP requests (e.g., read versus write, SW prefetch versus hardware prefetch) can have access to available ATP slots or for a given clock cycle fairly or according to one or more predefined priority policies. Arbitrate 606 can determine an order in which ATP requests are serviced. Arbitrate 606 can adjust the frequency of servicing of certain type(s) of ATP requests based on workload demands, pre-assigned quotas, or priority policies. By appropriately selecting an ATP request to service when there are competing ATP requests, arbitrate 606 prevents one type of ATP from monopolizing ATP resources.

In some embodiments, arbitrate 606 may implement a pure round-robin policy (e.g., one after another in a round-robin fashion) if various ATP streams have ATP quotas available.

In some embodiments, arbitrate 606 may temporarily cease servicing ATP requests from a particular ATP stream if the ATP stream does not have ATP quota available or has reached its quota, until ATP slot(s) become available again for the ATP stream.

In some embodiments, arbitrate 606 may implement a weighted round-robin policy. In a weighted round-robin policy, the “weights” determine how many consecutive requests from each ATP stream (such as read versus write ATP streams, SW prefetch versus HW prefetch ATP streams) are allowed to be serviced by arbitrate 606 before arbitrate 606 switches to the other stream. For example, if the read ATP stream has a higher weight than the write ATP stream, arbitrate 606 will process more consecutive read ATP requests in succession before servicing a write ATP request, effectively prioritizing read operations according to the assigned weight. These weights can programmable and can be adjusted to match the workload characteristics or performance goals, allowing the data movement engine to allocate ATP slots in a way that favors the most critical or bandwidth-intensive stream while still ensuring that all streams receive fair access over time. In some implementations, the workloads associated with neural network operations may have more reads than writes (e.g., characterized by many more data reads of weights than data writes of activations). The weight for read ATP stream may be greater than the weight for write ATP stream.

In some embodiments, arbitrate 606 may implement a priority policy that favors servicing certain ATP requests, e.g., prioritizing between ATP requests associated with hardware prefetch mode and ATP requests associated with software prefetch mode. The prioritization can be implemented using a programmable ratio (or rate) that defines how many consecutive ATP requests for HW prefetch are allowed before an ATP request for SW prefetch is serviced. For example, a ratio of 4:1 means arbitrate 606 can process four ATP requests associated with HW prefetch for every one ATP request associated with SW prefetch, ensuring that ATP requests for HW prefetch, which is tied directly to ongoing or concurrent data movement, receives higher priority and greater access to ATP slots. This ratio-based approach allows arbitrate 606 to balance performance and fairness, preventing greedy ATP requests from SW prefetch from being starved while still favoring the more time-sensitive ATP requests from HW prefetch. Prioritizing hardware prefetch over software prefetch ensures that ongoing data movement is not stalled waiting for address translations, which is beneficial for maintaining high-throughput and low latency. ATP requests for HW prefetch are directly linked to real-time data transfers, making them more time-sensitive than ATP requests for SW prefetch, which are scheduled ahead of time for future operations. This prioritization balances immediate performance needs with preparatory translation warm up.

In some embodiments, arbitrate 606 (e.g., including an arbitration circuit) may select a selected address translation from a plurality of competing address translations based on a priority policy.

In some embodiments, the priority policy specifies a priority for address translations associated with concurrent data movement (e.g., HW prefetch) over address translations not associated with concurrent data movement (e.g., SW prefetch). The priority policy may specify selecting a number of one or more consecutive address translations associated with concurrent data movement (e.g., HW prefetch) before selecting a further number of one or more consecutive address translations not associated with concurrent data movement (e.g., SW prefetch). Arbitrate 606 in SW prefetch channel 408 may have access to information monitored by arbitrate 606 in a data channel with HW prefetch (e.g., data channel with HW prefetch 402 of FIG. 4) to apply the priority policy for a given memory interface (e.g., memory interface 138 of FIG. 4). In some embodiments, at least one or more of the number of one or more consecutive address translations associated with concurrent data movement (e.g., HW prefetch) and the further number of one or more consecutive address translations not associated with concurrent data movement (e.g., SW prefetch) are programmable or configurable. The number and the further number can be set by a compiler and/or by firmware.

In some embodiments, the priority policy specifies a further priority for address translations associated with data reads over address translations associated with data writes. The priority policy may specify selecting a number of one or more consecutive address translations associated with data reads before selecting a further number of one or more consecutive address translations associated with data writes. In some embodiments, at least one or more of the number of one or more consecutive address translations associated with data reads and the further number of one or more consecutive address translations associated with data writes are programmable or configurable. The number and the further number can be set by a compiler and/or by firmware.

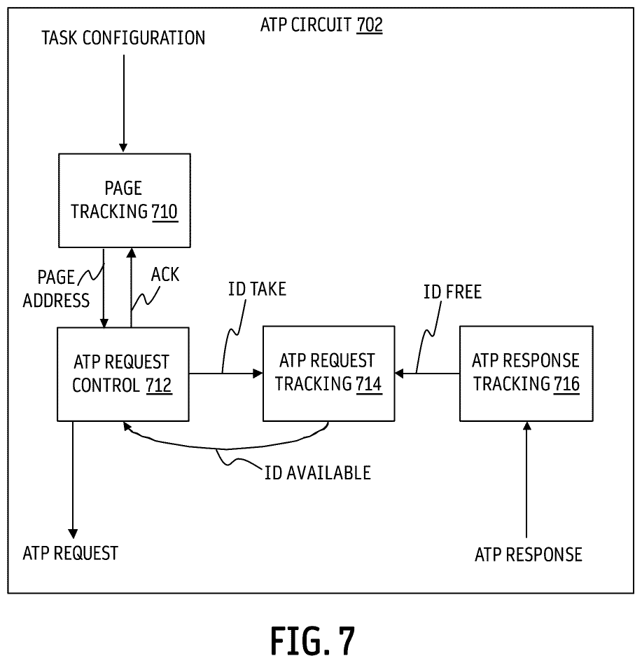

FIG. 7 illustrates address translation prefetch circuit 702, according to some embodiments of the disclosure. ATP circuit 702 can illustrate an implementation of read ATP circuit 602 or an implementation of write ATP circuit 604. ATP circuit 702 may include at least one or more of page tracking 710, ATP request control 712, ATP request tracking 714, and ATP response tracking 716.

Page tracking 710 can receive a task configuration specifying a data movement pattern. Based on the task configuration, e.g., the information related to the data movement pattern, page tracking 710 may determine memory addressing pattern information, e.g., stride, width, and number of dimensions. Page tracking 710 can determine or calculate, e.g., iteratively, one or more virtual memory page addresses that are associated with the data movement pattern, based on the memory addressing pattern information.

In some embodiments, page tracking 710 can determine or calculate one or more memory page addresses associated with the data movement pattern of a task configuration by adding page size bytes to an initial start address specified in the task configuration. Optionally, page tracking 710 can apply strides as specified in the task configuration. Page tracking 710, in each iteration, can determine a new page address that is different from a previous page address, and the new page address is transmitted to ATP request control 712. Page tracking 710 may stall until page tracking 710 receives an acknowledgement (ACK) from ATP request control 712. After receiving an ACK, page tracking 710 may determine a further page address in a subsequent iteration.

ATP request control 712 receives a page address from page tracking 710, and produces an ATP request specifying the page address.

In some embodiments, ATP request control 712 may issue an ATP request if, in response to, or based on a slot being available. ATP request tracking 714 may maintain statuses of a limited set of IDs. A status of an ID may indicate whether an ID is available or unavailable (e.g., pending or outstanding). The number of IDs in the set corresponds to a maximum number of outstanding memory requests allowed for a given point in time (e.g., a quota on the number of outstanding memory requests). If there is at least one ID in the set of IDs that are available, ATP request tracking 714 sends a signal to ATP request control 712 to indicate a specific ID is available. ATP request control 712 may, based on receiving the signal indicating that the specific ID is available, sends the ATP request using the specific ID, and sends a signal to ATP request tracking 714 to take the specific ID or indicate that the specific ID is no longer available. ATP request tracking 714 may mark the specific ID as being no longer available. When ATP response tracking 716 receives an ATP response for the specific ID, ATP response tracking 716 may send a signal to ATP request tracking 714 to indicate that the specific ID is now free (and available) because an ATP response has been received for the specific ID, indicating that the ATP request has been completed and is no longer outstanding. ATP request tracking 714 may mark the specific ID as being available. The specific ID is returned to the pool or set of available IDs for further ATP requests to be issued by ATP request control 712.

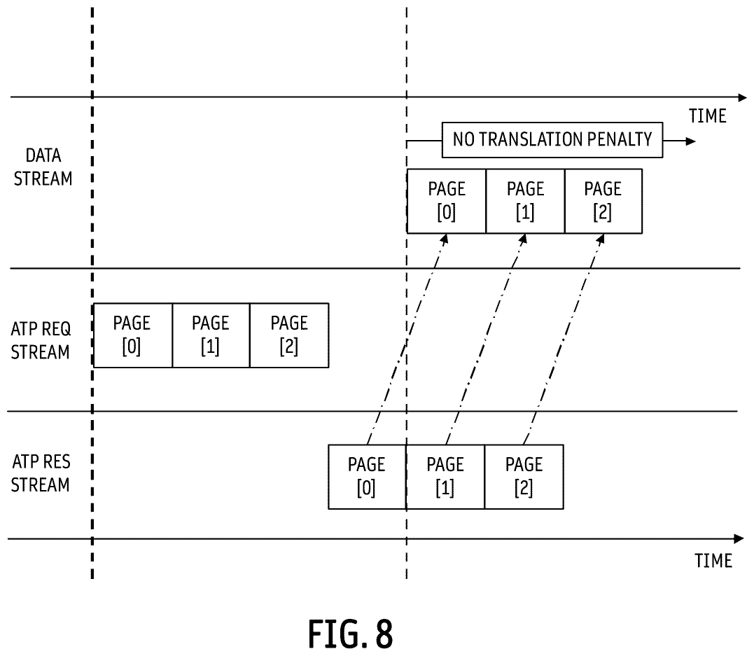

FIG. 8 illustrates timing of software address translation prefetching in advance of corresponding data movement, according to some embodiments of the disclosure. In software prefetch mode, a task configuration may trigger address translations for page addresses corresponding to page[0], page[1], and page[2], as an example. Software prefetch mode triggers address translations to be performed and does not have data movement directly associated with the address translations. However, it is expected that there is data movement to be performed at a later time. Once the address translations for page[0], page[1], page[2] are completed through software prefetch mode, the data movement for page[0], page[1], page[2] in the data stream associated with subsequent data movement tasks can occur with no address translation penalty.

### Hardware Prefetch Mode

FIG. 9 illustrates data channel with hardware prefetch 402, according to some embodiments of the disclosure. Data channel with hardware prefetch 402 may include one or more request generation blocks, e.g., read request generation 902 and write request generation 922. Data channel with hardware prefetch 402 may include one or more request gate logic blocks, e.g., read request gate logic 904 and write request gate logic 924. Data read requests can be issued to perform data read operations. Parallel request generation blocks with corresponding request gate logic blocks can issue requests for data read and data write operations respectively with external memory. Data write requests can be issued to perform data write operations.

Data channel with hardware prefetch 402 may include one or more ATP circuits, e.g., read ATP circuit 906 and write ATP circuit 926. Parallel ATP circuits corresponding to read and write data streams respectively can track both read and write operations respectively with external memory. An ATP circuit can implement logic for triggering one or more ATP requests and monitoring for one or more ATP responses. The ATP circuit in data channel with hardware prefetch 402 runs in sync with data movement and gates/blocks requests to be issued until appropriate address translation has been performed. Besides receiving a task configuration, the ATP circuit in data channel with hardware prefetch 402 further receives page address from a request generation block. The ATP circuit outputs a gating signal to the request gate logic block.

Read ATP circuit 906 may implement logic for triggering ATP requests associated with data read operations. Write ATP circuit 926 may implement logic for triggering ATP requests associated with data write operations. Read ATP circuit 906 and write ATP circuit 926 may be implemented similarly, or may be combined together.

In some embodiments, read ATP circuit 906 receives task configuration, and optionally page address from read request generation 902. The page address serves as a feedback signal from the read request stream to signal for read ATP circuit 906 to issue a further ATP read request.

Read request generation 902 may generate a data read request based on the task configuration and output the data read request to read request gate logic 904. Read ATP circuit 906 may output a gating signal to read request gate logic 904, where read request gate logic 904 gates the data read request from being issued in accordance to the gating signal from read ATP circuit 906. When read request gate logic 904 issues the data read request (e.g., when the read request is no longer gated or blocked), an ACK can be sent back to read request generation 902 to indicate to read request gate logic 904 can proceed to generate a further data read request.

In some embodiments, write ATP circuit 926 receives task configuration, and address from write request generation 922. The page address serves as a feedback signal from the write request stream to signal for write ATP circuit 926 to issue a further ATP write request.

Write request generation 922 may generate a data write request based on the task configuration and output the data write request to write request gate logic 924. Write ATP circuit 926 may output a gating signal to write request gate logic 924, where write request gate logic 924 gates the data write request from being issued in accordance to the gating signal from write ATP circuit 926. When write request gate logic 924 issues the data write request (e.g., when write request is no longer gated or blocked), an ACK can be sent back to write request generation 922 to indicate to write request gate logic 924 can proceed to generate a further data write request.

An ATP circuit, e.g., read ATP circuit 906 and write ATP circuit 926, of data channel with HW prefetch 402 may operate in two stages: a setup stage, and a throttling stage.

The setup stage warms up the cache with a startup stride (or burst) of address translations to ensure the address translation is ready when data is requested. The setup stage operates without any data movement synchronization and allows a burst or startup stride of address translations to be performed ahead of data movement.

The throttling stage ensures the ATP circuit adds proceeds with more address translation requests as the data movement requests proceed to request movement of more pages of data, while making sure that not too many ATP requests are being made, and the cache does not get overloaded. The throttling stage can be viewed as a stage where further data movement and further ATP requests are made in lock-step of each other. ATP circuit syncs with the data movement request stream. The ATP circuit 1002 modulates the rate of new ATP requests to match the actual rate of progression of the data movement being requested and performed.

In the setup stage, the ATP circuit can trigger a startup stride of address translations, e.g., a number of one or more address translations, from a virtual memory address space to a physical memory address space for the one or more pages in advance of a data movement request stream receiving a request to move the one or more pages between the memory and the further memory. The number of one or more address translations is programmable or configurable, e.g., by a compiler and/or by firmware. In some embodiments, the compiler can specify the number of one or more address translations in the task configuration.

In some embodiments, the number of address translations is based on address translation latency. Address translation latency is the time it takes from when an address translation prefetch request is issued until the translation is completed and ready for use (e.g., the address translation is stored in the cache). Performing a number of warm up address translations that correspond to the address translation latency ahead of requesting the data can ensure that by the time the data for the first page is requested, the address translation for the first page will have been completed.

In the throttling stage, the ATP circuit can trigger an address translation of a virtual memory address associated with a page in the one or more pages to a physical memory address prior to the data movement engine making a request to move the page between a memory and a further memory. Specifically, the ATP circuit may block the data movement engine from making a request to move the page until the ATP circuit confirms that the address translation of the virtual memory address associated with the page has been completed. The further address translation can be triggered prior to the data movement request stream receiving a further request to move the further page between the memory and the further memory.

In some embodiments, the ATP circuit triggers, based on detecting a page transition in a data movement request stream, a further address translation for a further virtual memory address associated with a further page in the one or more pages to a further physical memory address. The ATP circuit may receive a further indication that the further address translation is stored in the cache.

Arbitrate 606 of data channel with HW prefetch 402 may be implemented in the same manner or in a similar fashion as described with arbitrate 606 of SW prefetch channel 408.

Quota counter 680 of data channel with HW prefetch 402 may be implemented in the same manner or in a similar fashion as described with quota counter 680 of SW prefetch channel 408.

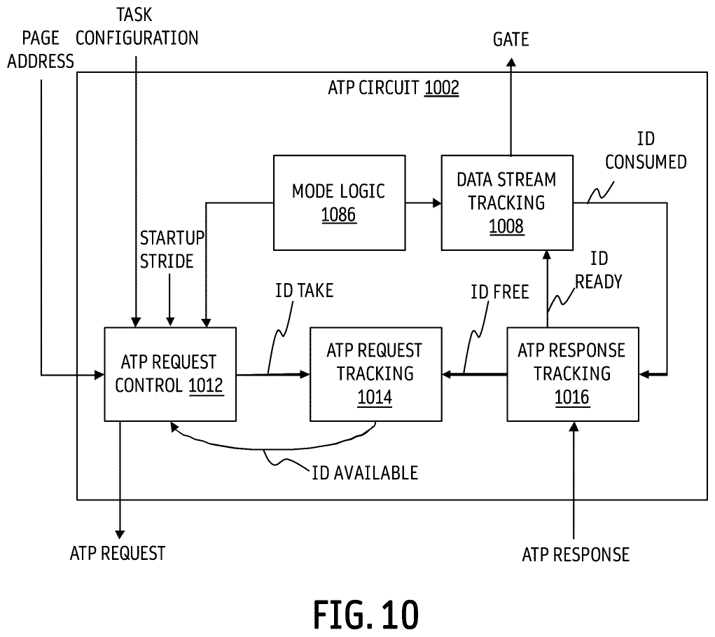

FIG. 10 illustrates ATP circuit 1002, according to some embodiments of the disclosure. ATP circuit 1002 can illustrate an implementation of read ATP circuit 906 or an implementation of write ATP circuit 926. ATP circuit 1002 may include at least one or more of ATP request control 1012, ATP request tracking 1014, ATP response tracking 1016, and data stream tracking 1008.

ATP circuit 1002 can trigger an address translation by outputting an ATP request. ATP circuit 1002 can monitor for an ATP response to assess whether the ATP request has been completed. ATP circuit 1002 can receive an indication in the ATP response that the address translation is stored in the cache.

ATP circuit 1002 may include mode logic 1086 to operate in one of the two operating modes: setup stage and throttling stage. In the setup stage, mode logic 1086 may signal to ATP request control 1012 to trigger a startup stride of ATP requests and may signal to data stream tracking 1008 to gate any data movement requests from being issued. When data stream tracking 1008 is operating in the setup stage, the gating signal output by data stream tracking 1008 gates any data requests from being issued by the data movement engine. In the throttling stage, mode logic 1086 may signal to ATP request control 1012 to monitor of page transitions in the page address and issues further ATP requests and may signal to data stream tracking 1008 to gate data movement requests whose address translations are not yet completed or ready. When data stream tracking 1008 is operating in the throttling stage, the gating signal output by data stream tracking 1008 gates data requests from being issued by the data movement engine that do not have address translations stored in the cache.

When ATP request control 1012 is operating in the setup stage, ATP request control 1012 can receive a task configuration specifying a startup stride, i.e., the number of initial address translations to perform in advance of data movement. In some embodiments, ATP request control 1012 can receive the startup stride from a configuration register. ATP request control 1012 may implement functionalities similar to page tracking 710 to determine a number of page addresses corresponding to the startup stride based on the task configuration and proceed to issue ATP requests for the number of page addresses. In some embodiments, ATP request control 1012 may receive the number of page addresses corresponding to the startup stride from a request generation block that is implementing functionalities similar to page tracking 710 and issue ATP requests for the number of page addresses accordingly.

When ATP request control 1012 is operating in the throttling stage, ATP request control 1012 can identify whether there is a page transition or crossing based on a change observed in the page address received from the request generation block. Based on the page transition, ATP request control 1012 triggers a further address translation to be performed.

ATP request control 1012 may, for a given page address, produce an ATP request specifying the page address.

In some embodiments, ATP request control 1012 may issue an ATP request if, in response to, or based on a slot being available ATP request tracking 1014 may maintain statuses of a limited set of IDs. A status of an ID may indicate whether an ID is available or unavailable (e.g., pending or outstanding). The number of IDs in the set corresponds to a maximum number of outstanding memory requests allowed for a given point in time (e.g., a quota on the number of outstanding memory requests). If there is at least one ID in the set of IDs that are available, ATP request tracking 1014 sends a signal to ATP request control 1012 to indicate a specific ID is available. ATP request control 1012 may, based on receiving the signal indicating that the specific ID is available, sends the ATP request using the specific ID, and sends a signal to ATP request tracking 1014 to take the specific ID or indicate that the specific ID is no longer available. ATP request tracking 1014 may mark the specific ID as being no longer available.

When ATP response tracking 1016 receives an ATP response for the specific ID, ATP response tracking 1016 may send a signal to data stream tracking 1008 to indicate that the address translation for the specific ID is ready (e.g., stored in the cache). The signal indicates to data stream tracking 1008 lets data stream tracking 1008 to change the gating signal. Data stream tracking 1008 can change the gating signal to allow data movement requests associated with address translations that are ready to issue.

Data stream tracking 1008 may monitor a data movement stream to detect whether an address translation for the specific ID is consumed, and signals to ATP response tracking 1016 accordingly to indicate that the address translation for the specific ID is no longer needed. In some embodiments, ATP response tracking 1016 maintains state information about whether the address translation obtained by an ATP response for a specific ID is ready or consumed. A ready state for a specific ID indicates that the address translation is cached in the cache and is ready to be used for data movement without suffering from address translation latency. A consumed state for a specific ID indicates that the data movement operation used or consumed the address translation for the specific ID.

After ATP response tracking 1016 receives an ATP response for the specific ID and a signal that indicates the address translation for the specific ID is consumed or no longer needed, ATP response tracking 1016 may send a signal to ATP request tracking 1014 to indicate that the specific ID is now free (and available), indicating that the ATP request has been completed and consumed and is no longer outstanding. ATP request tracking 1014 may mark the specific ID as being available. The specific ID is returned to the pool or set of available IDs for further ATP requests to be issued by ATP request control 1012.

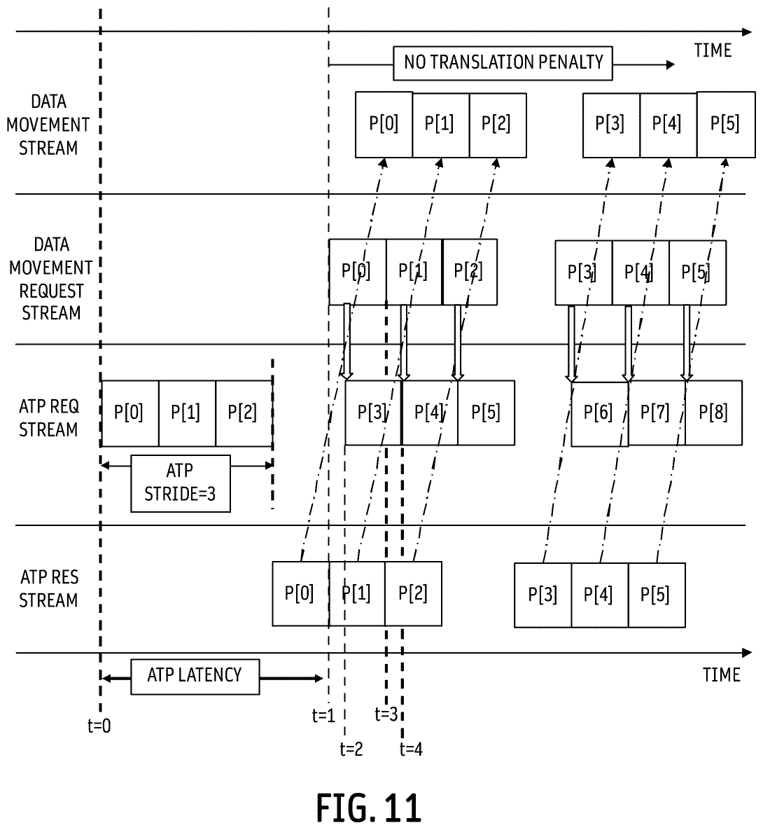

FIG. 11 illustrates timing of hardware address translation prefetching in advance of corresponding data movement, according to some embodiments of the disclosure. In hardware prefetch mode, a task configuration may trigger, at t=0, a startup stride of address translations for page addresses corresponding to page[0], page[1], and page[2], where startup stride is three as an example. The startup stride of address translations can correspond to or match address translation latency, ensuring that the address translation is ready just-in-time for the corresponding data movement operation.

Between t=0 to t=1, data movement requests are blocked or gated from being issued.

Once the address translation for page[0] is completed, at t=1, the data movement request for page[0] in the data movement request stream is unblocked and can be issued. The data movement of page[0] in the data movement stream can occur with no address translation penalty.

At t=1, when the data movement request for page[0] is unblocked and issued, the ATP mechanism moves on to generate a data movement request for the next page, i.e., page[1].

At t=2, the ATP mechanism detects the page transition in the data movement request stream (crossing from page[0] to page[1]) and triggers an ATP request for page[3] (the next page whose address translation is to be requested).

At t=3, because the address translation for page[1] has been completed, the data movement request for page[1] is unblocked and issued, the ATP mechanism moves on to generate a data movement request for the next page, i.e., page[2].

At t=4, the ATP mechanism detects the page transition in the data movement request stream (crossing from page[1] to page[2]) and triggers an ATP request for page[4].

The page transitions may continue to trigger further ATP requests to be issued for further pages. When the address translation is ready for a data movement request, the data movement request is unblocked and allowed to issue. The throttling mechanism may continue until no further data movement operations are to be performed. The initial setup stage races ahead so that address translations for individual iterations or progressions in the throttling stage can be ready just-in-time.

### Methods for Prefetching Address Translations

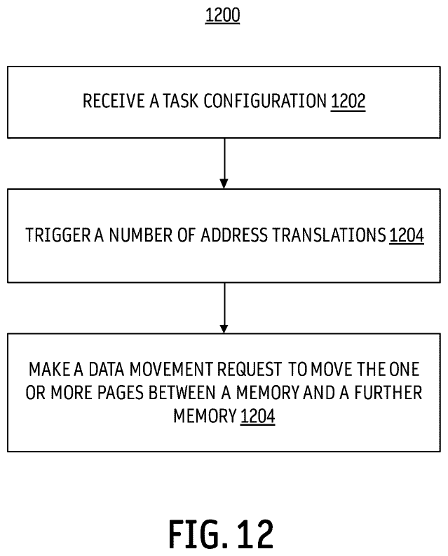

FIG. 12 is a flow diagram illustrating method 1200 for prefetching one or more address translations, according to some embodiments of the disclosure. One or more operations of method 1200 may be performed by one or more circuits in a DNN accelerator, such as the data movement engine of a DNN accelerator. One or more operations of method 1200 may be performed by one or more MMUs.

In 1202, a task configuration is received. The task configuration can include a data movement pattern of one or more pages corresponding to at least one or more of a weight and an activation of a neural network.

In 1204, a number of one or more address translations can be triggered. The one or more address translations comprise translations from a virtual memory address space to a physical memory address space for the one or more pages. For example, an address translation prefetch circuit of a data movement engine can trigger one or more MMUs to perform the number of one or more address translations. When the address translations are performed, one or more MMUs can store the one or more address translations in a cache.

In 1208, after the number of one or more address translations are performed, a data movement request is made to move the one or more pages between a memory and a further memory. In some embodiments, the data movement request can, e.g., leverage, use, or utilizes, the one or more address translations in the cache, to avoid incurring address translation latency penalty.

In some embodiments, the number of one or more address translations is programmable or configurable, e.g., based on an address translation latency.

In some embodiments, method 1200 further includes detecting a page transition in a data movement request stream, based on detecting the page transition, triggering a further address translation for a further page in the one or more pages, and after the further address translation is performed, making a further data movement request to move the further page between the memory and the further memory. In some embodiments, the further data movement request can, e.g., leverage, use, or utilizes, the further address translation in the cache, to avoid incurring address translation latency penalty.

In some embodiments, method 1200 further includes limiting a number of outstanding address translations during a time period.

In some embodiments, method 1200 further includes selecting a selected address translation from a plurality of competing address translations based on a priority policy.

### Exemplary Computing Device

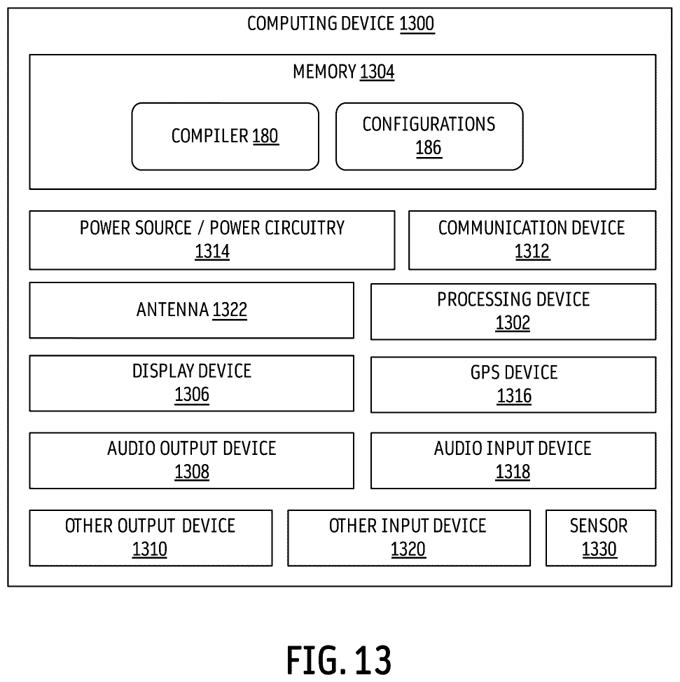

FIG. 13 is a block diagram of an apparatus or a system, e.g., an exemplary computing device 1300, according to some embodiments of the disclosure. One or more computing devices 1300 may be used to implement the functionalities described with the FIGS. and herein. A number of components illustrated in FIG. 13 can be included in the computing device 1300, but any one or more of these components may be omitted or duplicated, as suitable for the application. In some embodiments, some or all of the components included in the computing device 1300 may be attached to one or more motherboards. In some embodiments, some or all of these components are fabricated onto a single SoC die. Additionally, in various embodiments, the computing device 1300 may not include one or more of the components illustrated in FIG. 13, and the computing device 1300 may include interface circuitry for coupling to the one or more components. For example, the computing device 1300 may not include a display device 1306, and may include display device interface circuitry (e.g., a connector and driver circuitry) to which a display device 1306 may be coupled. In another set of examples, the computing device 1300 may not include an audio input device 1318 or an audio output device 1308 and may include audio input or output device interface circuitry (e.g., connectors and supporting circuitry) to which an audio input device 1318 or audio output device 1308 may be coupled.

Computing device 1300 may include a processing device 1302 (e.g., one or more processing devices, one or more of the same types of processing device, one or more of different types of processing device). Processing device 1302 may include electronic circuitry that processes electronic data from data storage elements (e.g., registers, memory, resistors, capacitors, quantum bit cells) to transform that electronic data into other electronic data that may be stored in registers and/or memory. Examples of processing device 1302 may include a CPU, a GPU, a quantum processor, a machine learning processor, an AI processor, a neural network processor, an AI accelerator, an ASIC, an analog signal processor, an analog computer, a microprocessor, a digital signal processor, an FPGA a tensor processing unit (TPU), a neural network hardware accelerator, an SoC (e.g., SoC 170 as illustrated in FIG. 1), a DNN accelerator (e.g., DNN accelerator 120 as illustrated in FIG. 1), an NPU, a DNN acceleration circuit (e.g., DNN acceleration circuit 102 as illustrated in FIG. 1), etc.

Computing device 1300 may include a memory 1304, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 1304 includes one or more non-transitory computer-readable storage media. In some embodiments, memory 1304 may include memory that shares a die with the processing device 1302.

In some embodiments, memory 1304 includes one or more non-transitory computer-readable media storing instructions executable to perform operations described with the FIGS. and herein. Exemplary parts, e.g., compiler 180, that may be encoded as instructions and stored in memory 1304 are depicted. Memory 1304 may store instructions that encode one or more exemplary parts, such as compiler 180. The instructions stored in the one or more non-transitory computer-readable media may be executed by processing device 1302. Memory 1304 may store instructions that causes processing device 1302 to perform one or more methods described and illustrated herein, such as operations to be performed by compiler 180.

In some embodiments, memory 1304 may store data, e.g., data structures, binary data, bits, metadata, files, blobs, etc., as described with the FIGS. and herein. In some embodiments, memory 1304 may store low-level machine-readable instructions, such as configurations 186. In some embodiments, memory 1304 may store at least one or more of weights and activations for a neural network. In some embodiments, memory 1304 may include a memory system as described and illustrated in FIG. 1. In some embodiments, memory 1304 may carry out address translation functions to support a data movement engine for the memory system.

In some embodiments, memory 1304 may store one or more DNNs (and or parts thereof). Memory 1304 may store training data for training (trained) a DNN. Memory 1304 may store instructions that perform operations associated with training a DNN. Memory 1304 may store input data, output data, intermediate outputs, intermediate inputs of one or more DNNs. Memory 1304 may store one or more parameters used by the one or more DNNs. Memory 1304 may store weights and/or activations of a DNN. Memory 1304 may store information that encodes how nodes of the one or more DNNs are connected with each other. Memory 1304 may store instructions to perform one or more operations of the one or more DNNs. Memory 1304 may store a model definition that specifies one or more operations of a DNN. Memory 1304 may store instructions, such as configuration descriptors, that are generated by a compiler based on the model definition.

In some embodiments, computing device 1300 may include a communication device 1312 (e.g., one or more communication devices). For example, the communication device 1312 may be configured for managing wired and/or wireless communications for the transfer of data to and from the computing device 1300. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1312 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. Communication device 1312 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1312 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication device 1312 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication device 1312 may operate in accordance with other wireless protocols in other embodiments. The computing device 1300 may include an antenna 1322 to facilitate wireless communications and/or to receive other wireless communications (such as radio frequency transmissions). Computing device 1300 may include receiver circuits and/or transmitter circuits. In some embodiments, Communication device 1312 may manage wired communications, such as electrical, optical, or any other suitable communication protocols (e.g., the Ethernet). As noted above, the communication device 1312 may include multiple communication chips. For instance, a first communication device 1312 may be dedicated to shorter-range wireless communications such as Wi-Fi or Bluetooth, and a second communication device 1312 may be dedicated to longer-range wireless communications such as global positioning system (GPS), EDGE, GPRS, CDMA, WiMAX, LTE, EV-DO, or others. In some embodiments, a first communication device 1312 may be dedicated to wireless communications, and a second communication device 1312 may be dedicated to wired communications.

Computing device 1300 may include power source/power circuitry 1314. The power source/power circuitry 1314 may include one or more energy storage devices (e.g., batteries or capacitors) and/or circuitry for coupling components of the computing device 1300 to an energy source separate from the computing device 1300 (e.g., DC power, AC power, etc.).

Computing device 1300 may include a display device 1306 (or corresponding interface circuitry, as discussed above). The display device 1306 may include any visual indicators, such as a heads-up display, a computer monitor, a projector, a touchscreen display, a liquid crystal display (LCD), a light-emitting diode display, or a flat panel display, for example.

Computing device 1300 may include an audio output device 1308 (or corresponding interface circuitry, as discussed above). The audio output device 1308 may include any device that generates an audible indicator, such as speakers, headsets, or earbuds, for example.

Computing device 1300 may include an audio input device 1318 (or corresponding interface circuitry, as discussed above). The audio input device 1318 may include any device that generates a signal representative of a sound, such as microphones, microphone arrays, or digital instruments (e.g., instruments having a musical instrument digital interface (MIDI) output).

Computing device 1300 may include a GPS device 1316 (or corresponding interface circuitry, as discussed above). The GPS device 1316 may be in communication with a satellite-based system and may receive a location of the computing device 1300, as known in the art.

Computing device 1300 may include a sensor 1330 (or one or more sensors). Computing device 1300 may include corresponding interface circuitry, as discussed above). Sensor 1330 may sense physical phenomenon and translate the physical phenomenon into electrical signals that can be processed by, e.g., processing device 1302. Examples of sensor 1330 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 1300 may include another output device 1310 (or corresponding interface circuitry, as discussed above). Examples of the other output device 1310 may include an audio codec, a video codec, a printer, a wired or wireless transmitter for providing information to other devices, haptic output device, gas output device, vibrational output device, lighting output device, home automation controller, or an additional storage device.

Computing device 1300 may include another input device 1320 (or corresponding interface circuitry, as discussed above). Examples of the other input device 1320 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 1300 may have any desired form factor, such as a handheld or mobile computer system (e.g., a cell phone, a smart phone, a mobile internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 1300 may be any other electronic device that processes data.

### Select Examples

Example 1 provides an apparatus, including a neural network acceleration circuit to perform one or more neural network operations based on at least one or more of a weight and an activation of a neural network, the neural network acceleration circuit including a memory for storing the at least one or more of the weight and the activation; a further memory; and a data movement engine to move at least one or more of the weight and the activation between the memory of the neural network acceleration circuit and the further memory, the data movement engine including an address translation prefetch circuit to: receive a task configuration indicating a data movement pattern of one or more memory pages; and trigger, based on at least the data movement pattern, an address translation of a virtual memory address associated with a memory page in the one or more memory pages to a physical memory address prior to the data movement engine making a request to move the memory page between the memory of the neural network acceleration circuit and the further memory.

Example 2 provides the apparatus of example 1, where the data movement pattern of the one or more memory pages is specified by a starting memory address and an amount of data to be moved.

Example 3 provides the apparatus of example 1 or 2, where: the task configuration is from a compiler, and the compiler is to generate configurations to configure the neural network acceleration circuit to perform the one or more neural network operations.

Example 4 provides the apparatus of any one of examples 1-3, where the address translation prefetch circuit triggers one or more address translations for the one or more memory pages of the data movement pattern prior to the data movement engine making the request to move the memory page.

Example 5 provides the apparatus of example 4, where a number of the one or more address translations is programmable or configurable.

Example 6 provides the apparatus of example 4 or 5, where a number of the one or more address translations is based on address translation latency.

Example 7 provides the apparatus of any one of examples 1-6, where the address translation prefetch circuit is further to: detect a page transition in a data movement request stream; and trigger, based on the page transition, a further address translation for a further virtual memory address associated with a further memory page in the one or more memory pages to a further physical memory address.

Example 8 provides the apparatus of example 7, where the address translation prefetch circuit is further to receive a further indication that the further address translation is completed.

Example 9 provides the apparatus of example 7 or 8, where the address translation prefetch circuit is further to: trigger the further address translation prior to the data movement engine making a further request to move the further memory page.

Example 10 provides the apparatus of any one of examples 1-9, where the data movement engine further includes a quota counter to limit a number of outstanding address translations during a time period.

Example 11 provides the apparatus of example 10, where the number of outstanding address translations is programmable or configurable.

Example 12 provides the apparatus of example 10 or 11, where the outstanding address translations correspond to data reads.

Example 13 provides the apparatus of any one of examples 10-12, where the outstanding address translations correspond to data writes.

Example 14 provides the apparatus of any one of examples 1-13, where the data movement engine further includes an arbitration circuit to select a selected address translation from a plurality of competing address translations based on a priority policy.

Example 15 provides the apparatus of example 14, where the priority policy specifies at least one or more of: a priority for address translations associated with concurrent data movement over address translations not associated with concurrent data movement, and selecting a number of one or more consecutive address translations associated with concurrent data movement before selecting a further number of one or more consecutive address translations not associated with concurrent data movement.

Example 16 provides the apparatus of example 15, where at least one or more of the number of one or more consecutive address translations associated with concurrent data movement and the further number of one or more consecutive address translations not associated with concurrent data movement are programmable or configurable.

Example 17 provides the apparatus of any one of examples 14-16, where the priority policy specifies at least one or more of: a further priority for address translations associated with data reads over address translations associated with data writes and selecting a number of one or more consecutive address translations associated with data reads before selecting a further number of one or more consecutive address translations associated with data writes.

Example 18 provides the apparatus of example 17, where at least one or more of the number of one or more consecutive address translations associated with data reads and the further number of one or more consecutive address translations associated with data writes are programmable or configurable.

Example 19 provides the apparatus of any one of examples 1-18, where the data movement engine is further to receive an indication that the address translation is completed.

Example 20 provides a data movement engine for a processing circuit, including a data movement request stream; and an address translation prefetch circuit to: receive a task configuration indicating a data movement pattern of one or more memory pages, the one or more memory pages corresponding to at least one or more of a weight and an activation of a neural network; and trigger, based at least on the data movement pattern, one or more address translations from a virtual memory address space to a physical memory address space for the one or more memory pages in advance of the data movement request stream receiving a request to move the one or more memory pages between a memory of the processing circuit and a further memory.

Example 21 provides the data movement engine of example 20, where the address translation prefetch circuit is further to receive an indication that the one or more address translations is completed.

Example 22 provides the data movement engine of example 21, where a number of the one or more address translations is programmable or configurable.

Example 23 provides the data movement engine of example 21 or 22, where the address translation prefetch circuit is further to: detect a page transition in the data movement request stream; and trigger, based at least on the page transition, a further address translation for a further memory page in the one or more memory pages.

Example 24 provides the data movement engine of example 23, where the address translation prefetch circuit is further to receive a further indication that the further address translation is completed.

Example 25 provides the data movement engine of example 23 or 24, where the address translation prefetch circuit is further to: trigger the further address translation prior to the data movement request stream receiving a further request to move the further memory page between the memory and the further memory.

Example 26 provides the data movement engine of any one of examples 20-25, further including a configuration register storing a number of outstanding address translations allowed for the address translation prefetch circuit during a time period.

Example 27 provides the data movement engine of any one of examples 20-26, further including an arbitration circuit to select a selected address translation from a plurality of competing address translations based on a priority policy.

Example 28 provides a method, including receiving a task configuration including a data movement pattern of one or more memory pages corresponding to at least one or more of a weight and an activation of a neural network; triggering, based at least on the data movement pattern, one or more address translations from a virtual memory address space to a physical memory address space for the one or more memory pages; and after the one or more address translations are performed, making a data movement request to move the one or more memory pages between a memory of a neural network acceleration circuit and a further memory.

Example 29 provides the method of example 28, where the data movement request utilizes the one or more address translations stored in a cache.

Example 30 provides the method of example 28 or 29, where a number of the one or more address translations is programmable or configurable based on an address translation latency.

Example 31 provides the method of any one of examples 28-30, further including detecting a page transition in a data movement request stream; based on detecting the page transition, triggering a further address translation for a further memory page in the one or more memory pages to be performed; and after the further address translation is performed, making a further data movement request to move the further memory page between the memory and the further memory.

Example 32 provides the method of example 31, where the further data movement request utilizes the further address translation stored in a cache.

Example 33 provides the method of any one of examples 28-32, further including limiting a number of outstanding address translations during a time period.

Example 34 provides the method of any one of examples 28-33, further including selecting a selected address translation from a plurality of competing address translations based on a priority policy.

Example A provides an apparatus comprising means for performing a method as described herein or a method of any one of examples 28-34.

Example B provides an integrated circuit or hardware circuitry to implement a method as described herein or a method of any one of examples 28-34.

### Variations and Other Notes

Although the operations of the example method shown in and described with reference to FIGS. are illustrated as occurring once each and in a particular order, it will be recognized that some operations may be performed in any suitable order and repeated as desired. Furthermore, the operations illustrated in FIGS. may be combined or may include more or fewer details than described.

The various implementations described herein may refer to AI, machine learning, and deep learning. Deep learning may be a subset of machine learning. Machine learning may be a subset of AI. In cases where a deep learning model is mentioned, if suitable for a particular application, a machine learning model may be used instead. In cases where a deep learning model is mentioned, if suitable for a particular application, a digital signal processing system may be used instead.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges. For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

For the purposes of the present disclosure, “A is less than or equal to a first threshold” is equivalent to “A is less than a second threshold” provided that the first threshold and the second thresholds are set in a manner so that both statements result in the same logical outcome for any value of A. For the purposes of the present disclosure, “B is greater than a first threshold” is equivalent to “B is greater than or equal to a second threshold” provided that the first threshold and the second thresholds are set in a manner so that both statements result in the same logical outcome for any value of B.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. An apparatus, comprising:
a neural network acceleration circuit to perform one or more neural network operations based on at least one or more of a weight and an activation of a neural network, the neural network acceleration circuit comprising a memory for storing the at least one or more of the weight and the activation;
a further memory; and
a data movement engine to move at least one or more of the weight and the activation between the memory of the neural network acceleration circuit and the further memory, the data movement engine comprising an address translation prefetch circuit to:
receive a task configuration indicating a data movement pattern of one or more memory pages; and
trigger, based on at least the data movement pattern, an address translation of a virtual memory address associated with a memory page in the one or more memory pages to a physical memory address prior to the data movement engine making a request to move the memory page between the memory of the neural network acceleration circuit and the further memory.

2. The apparatus of claim 1, wherein the data movement pattern of the one or more memory pages is specified by a starting memory address and an amount of data to be moved.

3. The apparatus of claim 1, wherein:
the task configuration is from a compiler, and
the compiler is to generate configurations to configure the neural network acceleration circuit to perform the one or more neural network operations.

4. The apparatus of claim 1, wherein the address translation prefetch circuit triggers one or more address translations for the one or more memory pages of the data movement pattern prior to the data movement engine making the request to move the memory page.

5. The apparatus of claim 1, wherein the address translation prefetch circuit is further to:
detect a page transition in a data movement request stream; and
trigger, based on the page transition, a further address translation for a further virtual memory address associated with a further memory page in the one or more memory pages to a further physical memory address.

6. The apparatus of claim 1, wherein the data movement engine further includes a quota counter to limit a number of outstanding address translations during a time period.

7. The apparatus of claim 1, wherein the data movement engine further includes an arbitration circuit to select a selected address translation from a plurality of competing address translations based on a priority policy.

8. The apparatus of claim 7, wherein the priority policy specifies at least one or more of: a priority for address translations associated with concurrent data movement over address translations not associated with concurrent data movement, and selecting a number of one or more consecutive address translations associated with concurrent data movement before selecting a further number of one or more consecutive address translations not associated with concurrent data movement.

9. The apparatus of claim 7, wherein the priority policy specifies at least one or more of: a further priority for address translations associated with data reads over address translations associated with data writes and selecting a number of one or more consecutive address translations associated with data reads before selecting a further number of one or more consecutive address translations associated with data writes.

10. A data movement engine for a processing circuit, comprising:
a data movement request stream; and
an address translation prefetch circuit to:
receive a task configuration indicating a data movement pattern of one or more memory pages, the one or more memory pages corresponding to at least one or more of a weight and an activation of a neural network; and
trigger, based at least on the data movement pattern, one or more address translations from a virtual memory address space to a physical memory address space for the one or more memory pages in advance of the data movement request stream receiving a request to move the one or more memory pages between a memory of the processing circuit and a further memory.

11. The data movement engine of claim 10, wherein the address translation prefetch circuit is further to receive an indication that the one or more address translations is completed.

12. The data movement engine of claim 10, wherein a number of the one or more address translations is programmable or configurable.

13. The data movement engine of claim 10, wherein the address translation prefetch circuit is further to:
detect a page transition in the data movement request stream; and
trigger, based at least on the page transition, a further address translation for a further memory page in the one or more memory pages.

14. The data movement engine of claim 10, further comprising:
a configuration register storing a number of outstanding address translations allowed for the address translation prefetch circuit during a time period.

15. The data movement engine of claim 10, further comprising:
an arbitration circuit to select a selected address translation from a plurality of competing address translations based on a priority policy.

16. A method, comprising:
receiving a task configuration comprising a data movement pattern of one or more memory pages corresponding to at least one or more of a weight and an activation of a neural network;
triggering, based at least on the data movement pattern, one or more address translations from a virtual memory address space to a physical memory address space for the one or more memory pages; and
after the one or more address translations are performed, making a data movement request to move the one or more memory pages between a memory of a neural network acceleration circuit and a further memory.

17. The method of claim 16, wherein the data movement request utilizes the one or more address translations stored in a cache.

18. The method of claim 16, wherein a number of the one or more address translations is programmable or configurable based on an address translation latency.

19. The method of claim 16, further comprising:
limiting a number of outstanding address translations during a time period.

20. The method of claim 16, further comprising:
selecting a selected address translation from a plurality of competing address translations based on a priority policy.
